(19) United States
(12) Patent Application Publication
(10) Pub. No.: US 2024/0256966 A1
(43) Pub. Date: Aug. 1, 2024

(54) BINARIZED TRANSFORMER NEURAL NETWORKS FOR SEQUENCE GENERATION

(71) Applicant: Google LLC, Mountain View, CA (US)

(72) Inventors: Ankush Garg, Sunnyvale, CA (US); Yichi Zhang, Ithaca, NY (US); Yuan Cao, Mountain View, CA (US); Lukasz Lew, Sunnyvale, CA (US); Orhan Firat, Mountain View, CA (US); Behrooz Ghorbani, San Francisco, CA (US)

(21) Appl. No.: 18/424,660

(22) Filed: Jan. 26, 2024

Related U.S. Application Data
(60) Provisional application No. 63/441,436, filed on Jan. 26, 2023.

(51) Int. Cl. G06N 20/00

(52) U.S. Cl. CPC G06N 20/00

(57) ABSTRACT

Methods, systems, and apparatus, including computer programs encoded on computer storage media, for performing sequence generation tasks using binarized neural networks. The binarized neural network is an attention neural network configured to perform the task and the attention neural network includes a plurality of attention blocks, with each block including an attention block and a binarized feedforward block.

### CROSS-REFERENCE TO RELATED APPLICATIONS

This application claims the benefit of U.S. Patent Application Ser. No. 63/441,436, filed on Jan. 26, 2023. The disclosure of the prior application is considered part of (and is incorporated by reference in) the disclosure of this application.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that that performs a machine learning task on a network input to generate a network output for the machine learning task. To perform the machine learning task, the system includes a neural network that receives the network input and generates the network output. The neural network can have any appropriate neural network architecture, but generally includes multiple layer blocks that each include an attention block and a binarized feedforward block. The attention block can also be a binarized attention block. For example, the layer blocks can be arranged into an encoder-decoder Transformer architecture or a decoder-only Transformer architecture.

Particular embodiments of the subject matter described in this specification can be implemented so as to realize one or more of the following advantages.

Neural sequence processing neural networks, e.g., encoder-decoder Transformers and decoder-only Transformers, have greatly increased in size, i.e., in number of parameters, in the last several years. As a result, performance of these neural networks on a variety of tasks that require generating output sequences, e.g., natural language output sequences or other types of sequences of tokens, has significantly improved.

However, this aggressive scaling trend has resulted in unprecedented challenges in model serving. In particular, the inference cost, i.e., the cost of performing inference using a deployed model, grows exponentially with model size. However, the energy efficiency of hardware used to run these models is not keeping pace. For example, the energy required for FP32 (32-bit floating point) operations improved by only 2.5× from 2007-2018, from 45 nm to 7 nm process nodes. Over the same period, DRAM access energy has only improved by 6.3×. The ever-growing gap between the inflation of model size and inefficiency in hardware energy utility is causing inference energy to grow exponentially, which is becoming a major part of the cost of running Transformer neural networks, e.g., in datacenters.

The inter-chip communication overhead also becomes non-negligible as model size increases. Data parallelism alone is no longer sufficient for models at such a large scale since one matrix multiplication cannot fit on a single accelerator chip. Each weight tensor in the PaLM Transformer model, for example, is partitioned across a large number of, e.g., over one thousand, hardware accelerators, e.g., TPUs, within one or more data centers. This leads to a huge overhead on transferring the weights and intermediate activations across the datacenter networks.

Additionally, latency-critical applications now experience only minor performance benefits from optimization techniques like parameter caching. For example, loading model parameters from DRAM to on-chip accelerator memory often takes a lot of time during inference. In the past, parameter caching was an effective optimization for latency because it reused model weights and avoided off-chip memory transfers. However, evaluations on edge TPUs reported that this method works best for models with fewer than 30 million parameters. For larger models, parameter caching even becomes harmful. Benefits from compiler optimizations are diminishing, and the serving latency becomes almost proportional to the model parameter count.

Quantization can significantly reduce inference cost. Binarization, as described in this specification, is an extreme case of quantization where both the weights and activations of a matrix multiplication (matmul) are quantized to a single bit. For example, compared to the Brain floating-point format (bfloat16), binarization reduces the weight size of a model by 16×, thus significantly lowering the memory and communication overhead when the model is deployed for performing inference.

Moreover, a binarized matmul can be carried out by XNOR operations followed by a population count, which is estimated to be 256 more energy-efficient than the bfloat16 counterpart.

Some existing techniques show that BERT models (encoder-only Transformer models for text classification) can be binarized for pretraining. However, it is important to note that the BERT models are very different from sequence generation models. One key difference is the architecture: while a sequence generation model has both an encoder and a decoder or only a decoder, BERT only has an encoder. This difference can impact the quality of encoder quantization because every cross attention layer in the decoder requires outputs from the encoder. Another difference is that sequence generation model inference produces a sequence of text, while BERT performs a single text classification. This is critical because each word in the output sequence affects the generation of the next word. The sampling distribution of a word is therefore crucial and should be preserved after binarization, but for BERT, only the peak of the logits needs to be preserved. Due to these differences, directly applying BERT binarization techniques to sequence generation models can easily result in a lower quality model or a model that does not converge during training.

This specification generally describes techniques for adapting a Transformer neural network, e.g., an encoder-decoder Transformer or a decoder-only Transformer, to allow the neural network to be effectively binarized while maintaining high accuracy on a variety of tasks that require generating an output sequence, e.g., neural machine translation. In particular, by leveraging scaling factors, e.g., constant scaling factors or scaling factors generated by LayerNorm operations, and, optionally, additional residual connections, the resulting modified architecture can be efficiently binarized to have similar quality to architectures that use floating point weights and activations. Additionally, as described above, the binarized operations can be efficiently implemented in cost and energy effective specialized hardware.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network system.

FIG. 2 shows an example architecture of a binarized feedforward block within a layer block of the attention neural network.

FIG. 3 shows an example architecture of an attention block within a layer block of the attention neural network.

FIG. 4 is a flow diagram of an example process for processing a layer input using a layer block.

FIG. 5 shows an example of the performance of the described techniques relative to a set of baseline techniques.

FIG. 6 is an example of the performance of various variants of the described techniques on a neural machine translation task.

Like reference numbers and designations in the various drawings indicate like elements.

### DETAILED DESCRIPTION

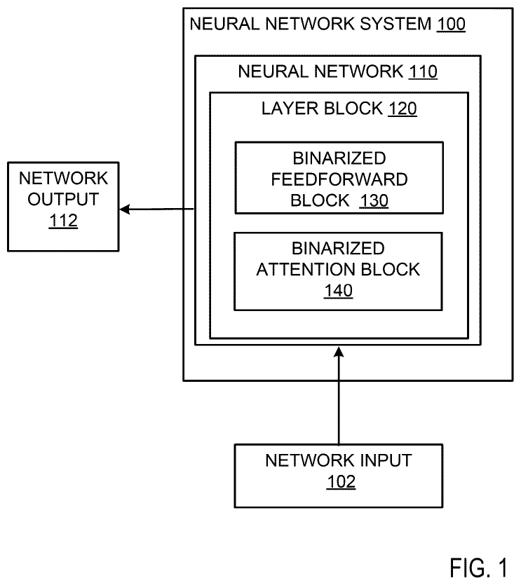

FIG. 1 shows an example neural network system 100. The neural network system 100 is an example of a system implemented as computer programs on one or more computers in one or more locations, in which the systems, components, and techniques described below can be implemented.

The system 100 performs a machine learning task on a network input 102 to generate a network output 112 for the machine learning task.

The machine learning task can be any machine learning task that generates a network output 112 that is an output sequence from a network input 102.

Some examples of machine learning tasks that the system 100 can be configured to perform follow.

For example, the input and the output sequence may each comprise a sequence of tokens.

For example in some implementations the input tokens and the output tokens each represent words, wordpieces or characters in a natural language. A wordpiece may be a sub-word (part of a word), and may be an individual letter or character. As used here, “characters” includes Chinese and other similar characters, as well as logograms, syllabograms and the like.

Some of these implementations may be used for natural language tasks such as providing a natural language response to a natural language input, e.g. for question answering, or for text completion. In some implementations the input sequence may represent text in a natural language and the output sequence may represent text in the same natural language, e.g. a longer item of text. For example in some implementations the input sequence may represent text in a natural language and the output sequence may represent the same text with a missing portion of the text added or filled in. For example the output sequence may represent a predicted completion of text represented by the input sequence. Such an application may be used, e.g. to provide an auto-completion function e.g. for natural language-based search. In some implementations the input sequence may represent a text in a natural language e.g. posing a question or defining a topic, and the output sequence may represent a text in a natural language which is a response to the question or about the specified topic.

As another example the input sequence may represent a first item of text and the output sequence may represent a second, shorter item of text e.g. the second item of text may be a summary of a passage that is the first item of text. As another example the input sequence may represent a first item of text and the output sequence may represent a simplification of the first item of text. As another example the input sequence may represent a first item of text and the output sequence may represent an aspect of the first item of text e.g. it may represent an entailment task, a paraphrase task, a textual similarity task, a sentiment analysis task, a sentence completion task, a grammaticality task, a parsing task, e.g., constituency parsing, and in general any natural language understanding task that operates on a sequence of text in some natural language e.g. to generate an output that classifies or predicts some property of the text. For example some implementations may be used to identify a natural language of the first item of text, or of spoken words where the input is audio (as described below).

Some implementations may be used to perform neural machine translation. Thus in some implementations the input tokens represent words, wordpieces, or characters in a first natural language and the output tokens represent words, wordpieces or characters in a second, different natural language. That is, the input sequence may represent input text in the first language and the output sequence may represent a translation of the input text into the second language.

Some implementations may be used for automatic code generation. For example the input tokens may include tokens that represent words, wordpieces or characters in a first natural language and the output tokens may represent instructions in a computer programming or markup language, or instructions for controlling an application program to perform a task e.g. build a data item such as an image or web page.

Some implementations may be used for speech recognition. In such applications the input sequence may represent spoken words and the output sequence may represent a conversion of the spoken words to a machine-written representation e.g. text. Then the input tokens may comprise tokens representing an audio data input including the spoken words e.g. characterizing a waveform of the audio in the time domain or in the time-frequency domain. The output tokens may represent words, wordpieces, characters, or graphemes of a machine-written, e.g. text, representation of the spoken input, that is representing a transcription of the spoken input.

Some implementations may be used for handwriting recognition. In such applications the input sequence may represent handwritten words, syllabograms or characters and the output sequence may represent a conversion of the input sequence to a machine-written representation e.g. text. Then the input tokens may comprise tokens representing portions of the handwriting and the output tokens may represent words, wordpieces, characters or graphemes of a machine-written, e.g. text, representation of the spoken input.

Some implementations may be used for text-to-speech conversion. In such applications the input sequence may represent text and the output sequence may represent a conversion of the text to spoken words. Then the input tokens may comprise tokens representing words or wordpieces or graphemes of the text and the output tokens may represent portions of audio data for generating speech corresponding to the text, e.g. tokens characterizing a portion of a waveform of the speech in the time domain or in the time-frequency domain, or phonemes.

In some implementations the input sequence and the output sequence represent different modalities of input. For example the input sequence may represent text in a natural language and the output sequence may represent an image or video corresponding to the text; or vice-versa. In general the tokens may represent image or video features and a sequence of such tokens may represent an image or video. There are many ways to represent an image (or video) using tokens. As one example an image (or video) may be represented as a sequence of regions of interest (RoIs) in the image, optionally including one or more tokens for global image features. For example an image may be encoded using a neural network to extract RoI features; optionally (but not essentially) a token may also include data, e.g. a position encoding, representing a position of the RoI in the image. As another example, the tokens may encode color or intensity values for pixels of an image. As another example, some image processing neural network systems e.g. autoregressive systems, naturally represent images as sequences of image features.

As another example, the system 100 may be used to process images instead of or as well as text (e.g. if trained on images instead of or as well as text).

Thus in some implementations at least one of the input sequence and the output sequence is a sequence representing an image or video, and the tokens represent the image or video. For example the input sequence may be a sequence of text, the input tokens may represent words, wordpieces, or characters and the output sequence may comprise output tokens representing an image or video e.g. described by the text, or providing a visual answer to a question posed by the text, or providing a visualization of a topic of the text. In another example the input sequence may comprise a sequence of input tokens representing an image or video, and the output tokens may represent words or wordpieces, or characters representing text e.g. for a description or characterization of the image or video, or providing an answer to a question posed visually by the image or video, or providing information on a topic of a topic of the image or video.

In some other implementations both the input sequence and the output sequence may represent an image or video, and both the input tokens and the output tokens may represent a respective image or video. In such implementations the method/system may be configured to perform an image or video transformation. For example the input sequence and the output sequence may represent the same image or video in different styles e.g. one as an image the other as a sketch of the image; or different styles for the same item of clothing.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

In some implementations the input sequence represents a sequence of actions to be performed by an agent e.g. a mechanical agent in a real-world environment implementing the actions to perform a mechanical task. The output sequence may comprise a modified sequence of actions e.g. one in which an operating parameter, such as a speed of motion or power consumption, has a limited value; or one in which or safety or other boundary is less likely to be crossed. Then both the input tokens and the output tokens may represent the actions to be performed.

In some implementations the input sequence represents a sequence of health data and the output sequence may comprise a sequence of predicted treatment. Then the input tokens may represent any aspect of the health of a patient e.g. data from blood and other medical tests on the patient and/or other patient data; and the output tokens may represent diagnostic information e.g. relating to a disease status of the patient and/or relating to suggested treatments for the patient, and/or relating to a likelihood of an adverse health event for the patient.

In some implementations the input sequence represents a time series and the output sequence may comprise a continuation of the time series. For example the input sequence may be a sequence representing the output of an electricity generating plant, e.g. a solar or wind electricity generating plant, or a sequence representing electricity consumption, and the output sequence may provide a forecast of the electricity generated or consumed. As another example the input sequence may be a sequence representing a level of traffic on one or more roads and the output sequence may provide a forecast of the future traffic.

In some implementations, each network input in the input sequence may comprise a data element embedding. As used herein an embedding refers to an ordered collection of numerical values, e.g., a vector, matrix, or other tensor of numerical values.

For example the data element embeddings may represent the pixels of an image and the network output may comprise a classification output, e.g. that includes a respective score for each object category in a set of possible object categories, defining a likelihood that the image depicts an object that belongs to the object category.

In some implementations the data element embeddings represent audio samples in an audio waveform and the system is configured to perform speech recognition, i.e., to generate a network output that defines a sequence of phonemes, graphemes, characters, or words corresponding to the audio waveform.

In some implementations, the data element embeddings represent words in a sequence of words and the system is configured to perform a natural language processing task, e.g., topic classification or summarization. To perform topic classification, the network output can include a respective score for each topic category in a set of possible category categories, e.g. the score for a topic category can define a likelihood that the sequence of words pertains to the topic category.

In some implementations, the system 100 is configured to perform an audio processing task. For example, if the data element embeddings represent a spoken utterance, then the network output may be a score for each of a set of pieces of text, each score representing an estimated likelihood that the piece of text is the correct transcript for the utterance. As another example, if the data element embeddings represent a spoken utterance, the network output can indicate whether a particular word or phrase (“hotword”) was spoken in the utterance. As another example, if the data element embeddings represent a spoken utterance, the network output can identify the natural language in which the utterance was spoken.

In some implementations, the system 100 can perform an image generation task, where the data element embeddings represent a conditioning input, e.g. text, and the network output defines a sequence of intensity value inputs for the pixels of an image.

In some implementations, the system 100 can perform an agent control task, where the data element embeddings represent a sequence of one or more observations and/or other data characterizing states of an environment and the network output comprises a policy output as previously described. The agent can be, e.g., a real-world or simulated mechanical agent (such as a robot or vehicle), a control system for an industrial facility, or a control system that controls a different kind of agent.

In some implementations, the system 100 can perform a point cloud processing task, e.g., where the data element embeddings represent a point cloud (e.g., generated by a lidar or radar sensor) and the network output characterizes, e.g., a type of object represented by the point cloud.

In some implementations, the system 100 is configured to perform a combination of multiple individual machine learning tasks, e.g., two or more of the machine learning tasks mentioned above.

The system 100 can process data element embeddings that represent any appropriate type of entity. For example, the entity can include an image, an audio waveform, a point cloud (e.g., generated by a lidar or radar sensor), a protein, a sequence of words (e.g., that form one or more sentences or paragraphs), a video (e.g., represented a sequence of video frames), or a combination thereof, e.g. multimodal data. The network output can characterize the entity or performs a processing task on the entity.

Implementations of the system/method can process multimodal data of a multimodal entity. Such an entity can include may comprise a combination of different types of data, such as image or video data and audio data, image or video data and language data, somatosensory input data (sensor data sensing the real-world environment of a physical agent, such as sensing touch, pressure, movement, temperature or vibration data) and motor feedback data (i.e. control data to control movement of the physical agent). When a multimodal entity is processed by the system/method embeddings of the data elements of the different modalities may be combined.

The network output for the multimodal entity may be as previously described. For example where the network output is a classification output for a classification task (e.g. defining a score for each category of a set of possible categories), this may be as previously described except that the network output is generated based upon the multimodal data embeddings provided as the input. Thus the machine learning task, e.g. classification, performed by the system may be performed better, e.g. more accurately, as a result. For example a classification task may be performed on a combination of video and (corresponding) audio data to obtain a more accurate classification result. As another example the machine learning task may be one that is based upon processing data of different modalities, e.g. in a task that combines video or image data and language data e.g. text data, to determine whether an image or video is described by a particular caption.

To perform the machine learning task, the system 100 includes an attention neural network 110 that receives the network input 102 and generates the network output 112. The neural network 100 can have any appropriate neural network architecture, but generally includes multiple layer blocks 120 that each include an attention block and a binarized feedforward block 130. The attention block can also be a binarized attention block 140.

Each block operates on a respective input sequence that includes a respective input vector at each of one or more positions.

The attention block, e.g., the binarized attention block 140, receives the input sequence for the block and applies an attention mechanism on the input sequence for the block to generate an attended input sequence, i.e., a sequence that includes a respective attended block input at each of the positions.

The attention mechanism applied by the attention block depends on the configuration of the neural network 100, as will be described in more detail below.

The binarized feedforward block 130 then operates on the attended input sequence to generate an output sequence for the block.

Generally, the blocks 120 within the attention neural network 110 can be arranged in any of a variety of configurations.

As one example, when the network input 102 is an input sequence, the attention neural network 110 can include an encoder neural network that includes a subset of the plurality of blocks 120 and that encodes the input sequence to generate a respective encoded representation of each input in the sequence.

In this example, the attention mechanism applied by the layer blocks in the encoder is a self-attention mechanism, e.g., a multi-head self-attention mechanism. In a self-attention mechanism, the input vectors and the memory vectors (vectors used to generate the keys and values for the block) operated on by the attention mechanism are the same, i.e., the vectors in the input sequence for the block.

In this example, the attention neural network 110 includes a decoder neural network that includes a different subset of the plurality of blocks. Generally, the decoder neural network operates auto-regressively to generate the outputs in the output sequence and the attention blocks within some or all of the blocks of the decoder apply masked (“causal”) self-attention over the partially generated output sequence. In masked self-attention, the input vectors and the memory vectors operated on by the attention mechanism are the same, but the attention mechanism is masked so that any given position in the input sequence does not attend over any positions after the given position in the input sequence.

When the neural network includes both an encoder and a decoder, some of the blocks in the decoder apply cross-attention into the encoded representations while others apply self attention over the output sequence, either masked or not masked.

In some cases, the attention neural network 110 can include a decoder that has blocks that apply cross-attention into encoded representations generated by an encoder that does not apply attention, e.g., a convolutional encoder, a multi-layer perceptron (MLP), and so on.

When the attention neural network 110 includes only a decoder neural network that operates directly on the input sequence, i.e., includes only a decoder and not an encoder, the attention blocks within the decoder can apply a causal self-attention mechanism over the input sequence.

The binarized feedforward block 130 and the binarized attention block 140 are referred to as “binarized” because some or all of the matrix multiplications that are performed by the blocks 130 and 140 are performed as binarized matrix multiplications.

In particular, binarization is a quantization technique that quantizes the weights and activations of a matrix multiplication (“matmul”), i.e., quantizes the weight values in one input matrix to the matrix multiplication and the activation values in the other input matrix to the matrix multiplication, to a single bit. That is, all numbers that are operated on by the matrix multiplication are quantized to a single bit. A “binarized” matrix multiplication is therefore a matrix multiplication between two binarized input matrices, i.e., two input matrices whose entries have both been quantized so that they are represented as a single bit.

In some implementations, the system 100 includes specialized hardware for performing binarized matrix multiplications in a low latency and energy efficient manner. For example, the system 100 can carry out a binarized matrix multiplications by a set of XNOR operations followed by a population count, which is estimated to be 256 more energy-efficient than a matrix multiplication performed on a bfloat16 counterpart.

As a particular example, the system 100 or another quantization systems can cast floating point values, e.g., the original entries of a given matrix that is being binarized to generate a binarized matrix, into binary values as follows:

$$Clip ( x , {x}_{min} , {x}_{max} ) := ( {x}_{max} , max ( {x}_{min} , x ) )$$

$${x}_{b} := ( floor ( clip ( \frac{x}{B} , - 1 + ϵ , 1 - ϵ ) ) + 0.5 ) \times B$$

where the operations are performed element-wise on x, x is the input tensor, x_{b} is the binary version of the input tensor x, ϵ is a small floating-point number that prevents overflow when taking the floor, floor is a function that takes as input a real number and returns as output the greatest integer less than or equal to the real number, and B is the binarization bound.

During training, the floor operation is ignored using the straight-through estimator, resulting in the gradient of the binarization function with respect to x being equal to x when x is between −B and B, inclusive, and zero otherwise. The bound B therefore serves as a hyperparameter that controls the range of the input values that will have non-zero gradients. B also serves as a scaling factor for the outputs since the binarization function maps each element of x to either −B/2 or +B/2.

The bound B can also generalize to a vector, depending on the granularity of binarization. The finest granularity, however, is one bound value for each dot product that needs to be performed as part of performing the matrix multiplication, i.e., per contraction dimension, so that the binarized matrix multiplication can effectively be accelerated in hardware by the system 100.

Put another way, for a dense layer in a Transformer of the form A. W, where A^{N×d}^{_{model}} is the input activations and W^{d}^{_{model}}^{×d}^{ₖ} is the model weights (and N, d_{model}, and dₖ are respective dimensions of the matrices A and W), the system instead computes a binarized matmul A_{b}·W_{b}. For this matrix multiplication, the system 100 can apply binarization bound B_{W} and B_{A} for weights and activations, respectively:

$${B}_{W} = max ( abs ( W ) = axis = {d}_{model} )$$

$${B}_{A} = max ( abs ( A ) = {d}_{model} )$$

where “axis” is the dimension along which max is taken. Using one axis only means the bound is per channel and per example. Note that the weight binarization bound is static during inference though it is updated at ever training iteration while the activation binarization bound is dynamic throughout both training and inference.

As described above, the blocks 122 each include a binarized feedforward block 130. In some implementations, the attention blocks are implemented using floating point computations while in other implementations the attention blocks are binarized attention block 140 that are also binarized.

Binarizing the feedforward blocks and optionally the attention blocks within the neural network 110 can generally dramatically improve the energy efficiency and latency of training and deploying the neural network 110

However, simply replacing the matrix multiplications performed by these blocks with binarized matrix multiplications can cause problems. For example, directly binarizing the weights preserves the model quality, but binarizing the input activations can cause the training to not converge in the context of machine translation or other sequence generation tasks. For example, this may be caused by the fact that a binarized matrix multiplication between a weight matrix and an activation matrix will have significantly higher variance than the corresponding floating point matrix multiplication. For example, for typical dimensions within a Transformer, binarization can inflate the variance of the dot product magnitude within a matmul by at least 256×, causing significant problems with respect to convergence during training.

To alleviate these issues, the system 100 modifies the architecture of the neural network 110 to improve the performance of the neural network 110 after binarization.

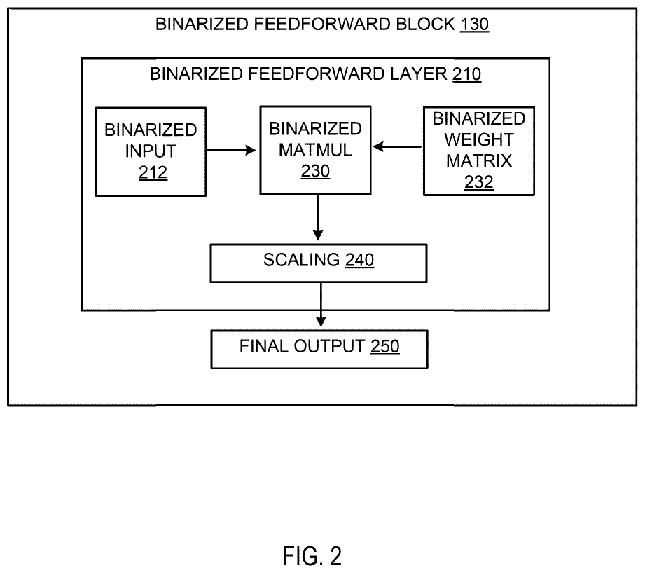

This is described below with reference to FIGS. 2-4.

FIG. 2 shows an example architecture of a binarized feedforward block 130 of a layer block 120 within the neural network 110.

Generally, the binarized feedforward block 130 has multiple binarized feedforward layers 210.

The block 130 receives an attended input sequence that is generated by the attention block within the layer block 120 and processes the attended input sequence using the feedforward layers 210 to generate a block output 220 for the layer block 120.

As described above, the attended input sequence generally includes a respective layer input at each of the one or more positions in the sequence.

Each binarized feedforward layer 210 is configured to, for each of the one or more positions, receive a binarized input 212 derived from the attended layer input at the position and generate an initial binarized output for the position.

As part of generating the initial binarized output, the layer 210 computes a binarized matrix multiplication 230 between the binarized input 212 and a binarized weight matrix 232 for the binarized feedforward layer 210. Optionally, the system can perform the multiplication for all of the positions as a single matmul by packing the binarized inputs 212 at the positions into a single input matrix.

The system can also perform other operations as part of generating the initial binarized output, e.g., adding a bias, applying a non-linear element-wise activation function, and so on. An example of this is described below.

As described above, simply using the initial binarized output generated from the output of the binarized matrix multiplication 230, as the output of the feedforward layer 210 can result in training failing to converge due to the large dot product variance that results from the binarization.

To account for this, the layer 210 scales 240 each element of the initial binarized output to generate a final output 250 of the binarized feedforward layer 210.

The layer 210 can perform this scaling 240 in any of a variety of ways.

For example, the layer 210 can divide each element of the initial binarized output by a scaling hyperparameter s. Dividing each element of the binarized output by s suppresses the dot-product variance inflation caused by the binarization and allows the training to converge. Thus, in this example, the binarized matrix multiplication that replaces A·W becomes A_{b}·W_{b}/s instead of A_{b}·W_{b}. As indicated above, s can be treated as a hyperparameter and can be determined through hyperparameter search or set to a known high-quality value, e.g., a value that is directly proportional to the square root of D, the dimensionality of the dot products that are performed during the matrix multiplication, in order to cancel the multiplicative effect of from D on the variance.

As another example, the layer 210 can perform the scaling 240 by applying a LayerNorm operation to the initial binarized output. In particular, while the scaling factor s enables the binarization of FFNs, it requires hyperparameter tuning, which can be challenging for large models. Instead, the system can perform the scaling 240 by replacing the operation of dividing by the scaling factor with applying a LayerNorm operation. A LayerNorm operation performed on a tensor x satisfies:

$$LN ( x ) = \frac{x - 𝔼 [ x ]}{\sqrt{Var ( x ) + ϵ}} \cdot γ + β$$

where the operations are performed element-wise, β and γ are learnable parameters, E[x] is the mean of the elements of x, Var(x) is the variance of x, and ϵ is a small floating-point number for numerical stability.

By applying LayerNorm, the system effectively applies a learnable scaling factor that is dynamic and adaptable during training. That is, as can be seen above, the learnable parameter γ can learn to incorporate the scaling factor s while still being dynamic throughout training. Moreover, applying LayerNorm also redistributes the input activations, as will be described in more detail below.

As indicated above, the binarized feedforward block 130 has multiple binarized feedforward layers 210. The binarized feedforward layers can generally have any appropriate configuration and the block 130 can generally include different numbers of layers 210.

As a specific example however, the binarized feedforward block 130 can include two layers 210, i.e., a first feedforward layer followed by a second feedforward layer.

In this specific example, the first feedforward layer is configured to receive a respective binarized attended layer input for each position, and, for each position, compute a binarized matrix multiplication between the binarized attended layer input and a binarized weight matrix for the first binarized feedforward layer, add a binarized bias to a product of the binarized matrix multiplication to generate a binarized sum and apply a binarized Rectified Linear Unit (ReLU) activation function to the binarized sum to generate the first initial binarized output. The first feedforward layer can then scale each element of the first initial binarized output by applying a LayerNorm operation to the first initial binarized output to generate a first binarized output for the position.

The second feedforward layer is then configured to receive the respective first binarized output for each position, and, for each position, compute a second binarized matrix multiplication between the first binarized output and a binarized weight matrix for the second binarized feedforward layer, and add a second binarized bias to a product of the second binarized matrix multiplication to generate a binarized sum. The layer then scales each element of the second initial binarized output by applying a LayerNorm operation to the second initial binarized output to generate a second binarized output for the position.

These operations can be represented as:

$$FFN ( A ) = LN ( LN {( max ( 0 , {A}_{b} {W}_{1 b} + {b}_{1} ) )}_{b} \cdot {W}_{2 b} + {b}_{2} )$$

As can be seen from the above, as a result of the binarized ReLU (max(0, A_{b} W_{1b}+b₁)) the activations matrix is all positive values. The binarization function would then map the entire matrix to B/2, which undermines the model training. With the help of LayerNorm, however, the activations are redistributed and more balanced in terms of the number of positive and negative values. This enables the normal {−1; +1} (bipolar) binarization of the second feedforward layer. By contrast, other approaches use a {0; +1} binarization to overcome the issue of constant positive values. This binarization yields a ternary matrix multiplication, which incurs nontrivial additional overhead if computed on a binary hardware accelerator. Thus, the redistribution of activations by LayerNorm helps avoid significant overhead during deployment.

Optionally, the feedforward block can then apply layer normalization, a residual connection, or both to the outputs of the last feedforward layer to generate the output of the layer block.

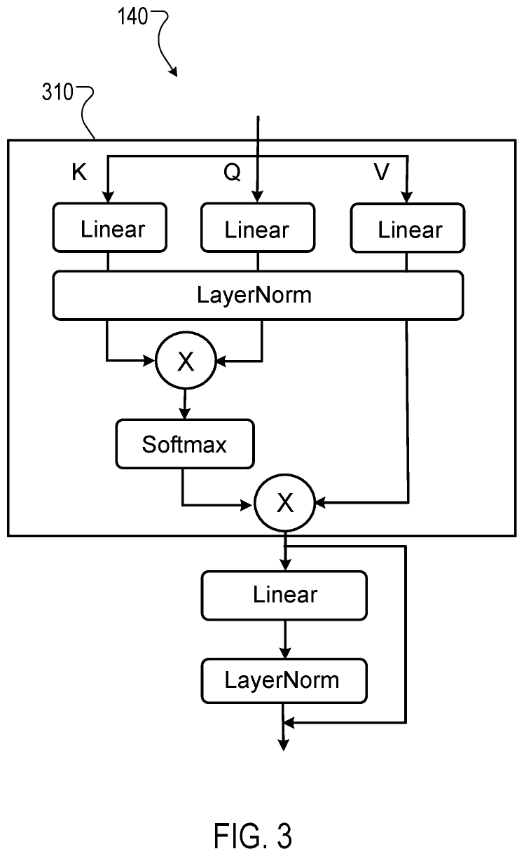

FIG. 3 shows an example architecture of a binarized attention block 140 of a layer block 120 within the neural network 110.

Generally, each attention block within the neural network 110 has one or more attention heads 310 and receives an input sequence for the block that includes a respective layer input at each of one or more position and generates an attended input sequence at least in part by applying an attention mechanism to the input sequence for the block, with the attended input sequence including a respective attended layer input at each of the one or more positions.

More specifically, each attention head 310 applies query-key-value attention to a set of queries for the attention head, a set of keys for the attention head, and a set of values for the attention head to generate an attention output and the attention block then generates the attended input sequence from the attention outputs for the one or more attention heads. For example, the attention block can concatenate the outputs of the heads and then apply a linear projection to the output to generate the attended input sequence.

As described above, the set of queries, keys, and values can be derived differently depending on the configuration of the neural network 110 and the position of the layer block within the neural network 110.

More specifically, when the attention block is a binarized attention block 140, each attention head 310 applies query-key-value attention by scaling the set of queries for the attention head, the set of keys for the attention head, and the set of values for the attention head by applying LayerNorm to the set of queries for the attention head, the set of keys for the attention head, and the set of values for the attention heads and then applying a binarized query-key-value attention to the scaled sets of queries, keys, and values for the attention head to generate a binarized attention output.

In particular, as shown in FIG. 3, the attention head 310 receives as input initial keys K, queries Q, and values V. The attention block 140 then applies respective binarized linear projections to K, Q and V to generate keys K′, queries Q′ and values V′. This is followed by scaling each of K′, Q′, and V′ by applying a LayerNorm operation to generate scaled queries, keys, and values.

The attention head 310 then applies a binarized attention mechanism by computing a binarized matrix multiplication between the scaled K′ and the scaled Q′, followed by a softmax operation, to generate a matrix of attention weights, and then computes a binarized matmul between the attention weights and the scaled V′ to generate a matrix of the attended outputs for the output head.

When there are multiple attention heads, the attention block 140 then concatenates the attended outputs generated by the heads and applies a binarized output linear projection to the concatenation to generate initial attended layer inputs.

As can be seen from FIG. 3, the attention block 140 also includes a shortcut (“residual”) connection to the output linear projection layer. In particular, in binary neural networks, gradients of a binarized layer are approximated due to the straight-through estimator described above. This will eventually lead the optimization into a different direction as we stack more binarized layers. Adding this residual connection can assist in mitigating this issue.

Optionally, after the initial attended layer inputs are generated, the attention block 140 can also apply layer normalization, a residual connection, or both, to the initial attended layer inputs to generate the attended layer inputs.

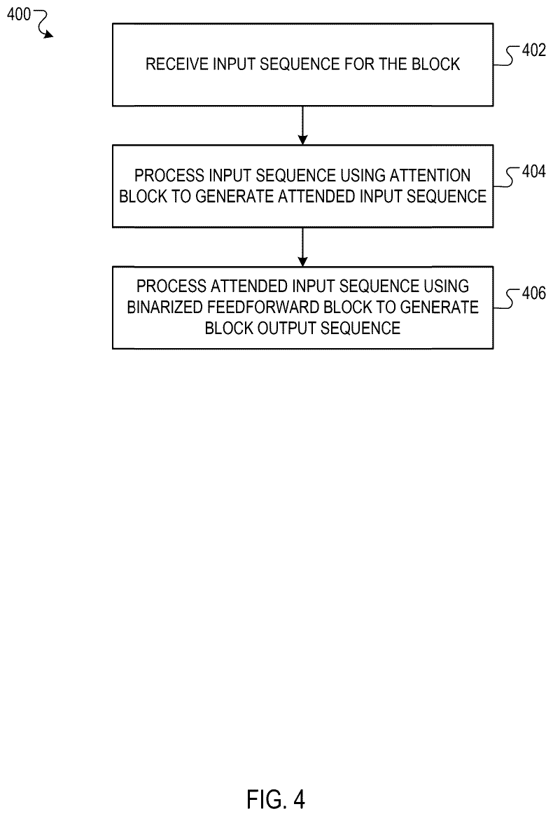

FIG. 4 is a flow diagram of an example process 400 for processing a layer input using a layer block. For convenience, the process 400 will be described as being performed by a system of one or more computers located in one or more locations. For example, a training system, e.g., the neural network system 100 of FIG. 1, appropriately programmed, can perform the process 400.

The system can perform the process 400 for each layer block in the attention neural network as part of generating the network output from the network input.

The system receives an input sequence for the block (step 402). The input sequence generally includes a respective layer input at each of one or more positions.

The system processes the input sequence for the block using the attention block within the layer block to generate an attended input sequence that has a respective attended layer input at each of the one or more positions (step 404). In particular, the attention block generates an attended input sequence at least in part by applying an attention mechanism to the input sequence for the block. As described above, in some implementations, the attention block performs the computation in floating point while in some other implementations, the attention block is a binarized attention block and performs the computation using binarized matrix multiplications as described above.

The system processes the attended input sequence using a binarized feedforward block to generate an output sequence for the layer block (step 406).

The binarized feedforward block includes multiple binarized feedforward layers that are each configured to, for each of the one or more positions, receive a binarized input derived from the attended layer input at the position and generate an initial binarized output for the position. As part of generating the initial binarized output, the system computes a binarized matrix multiplication between the binarized input and a binarized weight matrix for the binarized feedforward layer. The system then scales each element of the initial binarized output to generate a final output of the binarized feedforward layer.

The process 400 can be performed as part of predicting an output for an input for which the desired output, i.e., the output that should be generated by the system for the input sequence, is not known.

The process 400 can also be performed as part of processing inputs derived from a set of training data, i.e., inputs derived from a set of inputs for which the output that should be generated by the system is known, in order to train the attention neural network to determine trained values for the parameters of the attention neural network.

The system can repeatedly perform the process 400 on inputs selected from a set of training data as part of a conventional machine learning training technique to train the attention layers and the output layer(s) of the neural network, e.g., a gradient descent with backpropagation training technique that uses a conventional optimizer, e.g., stochastic gradient descent, RMSprop, or Adam optimizer, to optimize an objective function that is appropriate for the task that the informer neural network is configured to perform.

During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the informer neural network in parallel.

Moreover, the system can first pre-train the neural network on a large unsupervised data set through unsupervised learning, e.g., to minimize a next token prediction loss or other unsupervised loss, and then fine-tune the neural network on task-specific training data to optimize the objective function for the task.

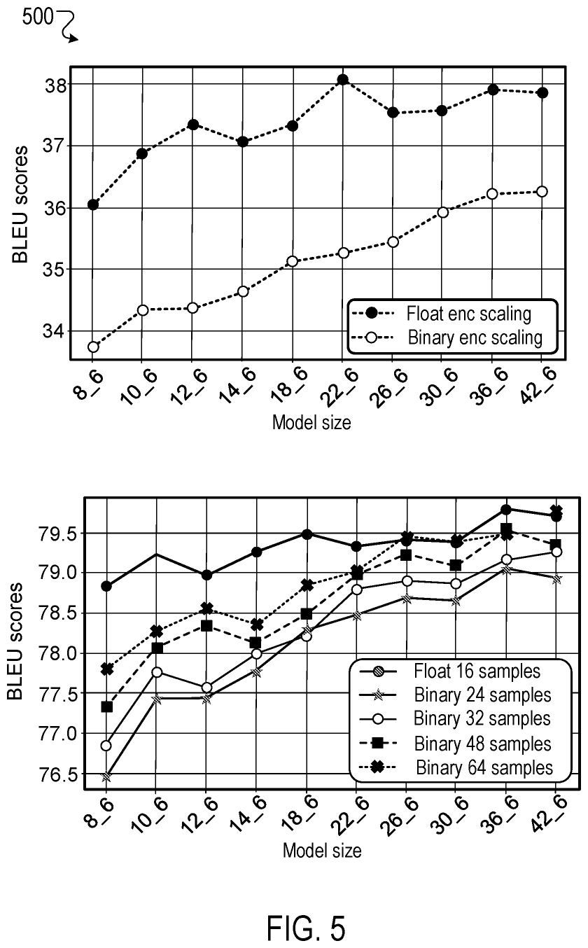

FIG. 5 is an example 500 of the performance of the described techniques relative to a set of baseline techniques on neural machine translation tasks in terms of both BLEU and BLEURT scores. In particular, the example 500 compares the performance of binarized neural networks relative to floating point neural networks with the same encoder-decoder Transformer architecture (other than the modifications described in this specification). As can be seen from FIG. 5, while at the same parameter count, the floating point neural networks achieve better performance, binarized neural networks with more parameters achieve comparable performance to floating point neural networks with fewer parameters. However, because the parameters of the binarized neural networks are represented using a single bit while the parameters of the floating point neural networks are represented in floating point, binarized neural networks can achieve comparable performance to floating point neural networks that consume significantly more memory, e.g., 5× more memory. Moreover, increasing the number of samples can further shrinking the gap between binarized and floating neural networks.

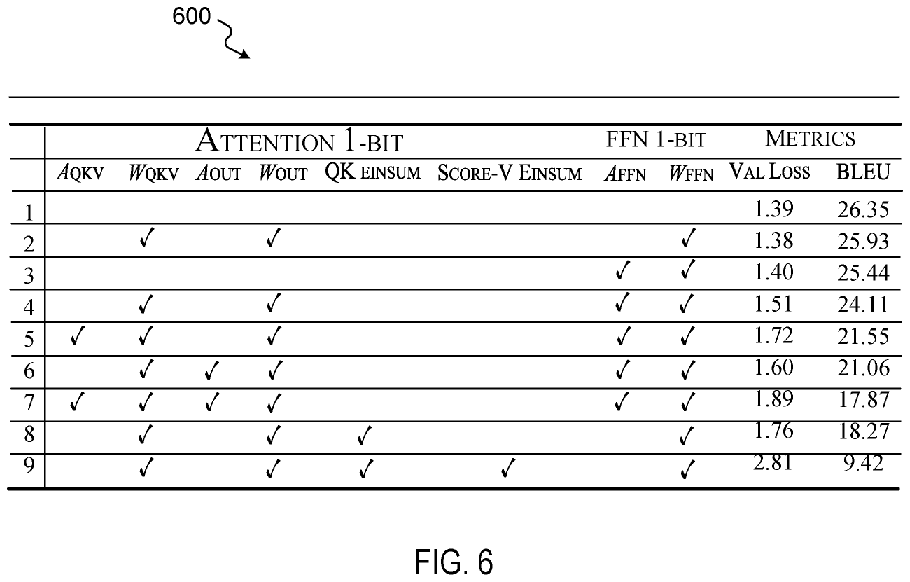

FIG. 6 is an example 600 of the performance of various variants of the described techniques on a neural machine translation task. In particular, FIG. 6 shows the performance, i.e., in terms of BLEU scores and validation loss, of the described techniques on the neural machine translation when different combinations of matmuls performed by the layer blocks are binarized. In FIG. 6, binarized activations or weights are labeled by checkmarks and activations and weights that don't have checkmarks are maintained in floating point.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for performing a machine learning task on a network input to generate a network output, the system comprising one or more computers and one or more storage devices storing instructions that, when executed by the one or more computers, cause the one or more computers to implement:
an attention neural network configured to perform the machine learning task, the attention neural network comprising a plurality of attention blocks, each block comprising an attention block and a binarized feedforward block,
the attention block configured to:
receive an input sequence for the block comprising a respective layer input at each of one or more positions; and
generate an attended input sequence at least in part by applying an attention mechanism to the input sequence for the block, the attended input sequence comprising a respective attended layer input at each of the one or more positions, and
the binarized feedforward block comprising a plurality of binarized feedforward layers that are each configured to, for each of the one or more positions:
receive a binarized input derived from the attended layer input at the position;
generate an initial binarized output for the position, comprising computing a binarized matrix multiplication between the binarized input and a binarized weight matrix for the binarized feedforward layer; and
scale each element of the initial binarized output to generate a final output of the binarized feedforward layer.

2. The system of claim 1, wherein scaling each element of the initial binarized output comprises:
dividing each element of the initial binarized output by a scaling hyperparameter.

3. The system of claim 1, wherein scaling each element of the initial binarized output comprises:
applying a LayerNorm operation to the initial binarized output.

4. The system of claim 3, wherein the binarized feedforward block comprises:
a first feedforward layer followed by a second feedforward layer, wherein:
the first feedforward layer is configured to receive a respective binarized attended layer input for each position, and, for each position:
generate a first initial binarized output for the position, comprising:
computing a binarized matrix multiplication between the binarized attended layer input and a binarized weight matrix for the first binarized feedforward layer;
adding a binarized bias to a product of the binarized matrix multiplication to generate a binarized sum; and
applying a binarized Rectified Linear Unit (ReLU) activation function to the binarized sum to generate the first initial binarized output; and
scale each element of the first initial binarized output by applying a LayerNorm operation to the first initial binarized output to generate a first binarized output for the position.

5. The system of claim 4, wherein the second feedforward layer is configured to receive the respective first binarized output for each position, and, for each position:
generate a second initial binarized output for the position, comprising:
computing a second binarized matrix multiplication between the first binarized output and a binarized weight matrix for the second binarized feedforward layer; and
adding a second binarized bias to a product of the second binarized matrix multiplication to generate a binarized sum; and
scale each element of the second initial binarized output by applying a LayerNorm operation to the second initial binarized output to generate a second binarized output for the position.

6. The system of claim 4, wherein the second feedforward layer is binarized using bipolar binarization.

7. The system of claim 1, wherein generating an attended input sequence at least in part by applying an attention mechanism to the input sequence for the layer comprises:
for each one or more attention heads:
applying query-key-value attention to a set of queries for the attention head, a set of keys for the attention head, and a set of values for the attention head to generate an attention output; and
generating the attended input sequence from the attention outputs for the one or more attention heads.

8. The system of claim 7, wherein for at least one of the blocks, the set of queries, the set of keys, and the set of values for each attention head are derived from the input sequence to the block.

9. The system of claim 8, wherein for at least one of the blocks for which the set of queries, the set of keys, and the set of values for each attention head are derived from the input sequence to the block: the query-key-value attention is causal query-key-value attention.

10. The system of claim 7, wherein for at least one of the blocks, the set of queries are derived from the input sequence to the block, and the set of keys and the set of values are derived from an encoded representation of the network input generated by an encoder neural network.

11. The system of claim 10, wherein the attention neural network comprises the encoder neural network and a subset of the plurality of blocks are in the encoder neural network.

12. The system of claim 7, wherein the attention block is a binarized attention block and wherein applying query-key-value attention comprises:
scaling the set of queries for the attention head, the set of keys for the attention head, and the set of values for the attention head by applying LayerNorm to the set of queries for the attention head, a set of keys for the attention head, and a set of values; and
applying a binarized query-key-value attention to the scaled sets of queries, keys, and values for the attention head to generate a binarized attention output.

13. The system of claim 12, wherein generating an attended input sequence at least in part by applying an attention mechanism to the input sequence for the layer comprises:
for each of the one or more attention heads:
applying a binarized linear projection to the binarized attention output to generate a binarized projected output;
scaling the binarized projected output by applying LayerNorm to the binarized projected output to generate a scaled binarized projected output; and
summing the binarized attention output and the scaled binarized projected output to generate a binarized output of the attention head.

14. The system of claim 12, wherein each attention head is configured to generate the set of queries for the attention head by applying a first binarized linear projection to a corresponding input, the set of keys for the attention head by applying a second binarized linear projection to a corresponding input, and the set of values for the attention head by applying a third binarized linear projection to a corresponding input.

15. A method comprising:
receiving a network input; and
processing the network input using an attention neural network configured to perform a machine learning task on the network input, the attention neural network comprising a plurality of attention blocks, each block comprising an attention block and a binarized feedforward block,
the attention block configured to:
receive an input sequence for the block comprising a respective layer input at each of one or more positions; and
generate an attended input sequence at least in part by applying an attention mechanism to the input sequence for the block, the attended input sequence comprising a respective attended layer input at each of the one or more positions, and
the binarized feedforward block comprising a plurality of binarized feedforward layers that are each configured to, for each of the one or more positions:
receive a binarized input derived from the attended layer input at the position;
generate an initial binarized output for the position, comprising computing a binarized matrix multiplication between the binarized input and a binarized weight matrix for the binarized feedforward layer; and
scale each element of the initial binarized output to generate a final output of the binarized feedforward layer.

16. The method of claim 15, wherein scaling each element of the initial binarized output comprises:
dividing each element of the initial binarized output by a scaling hyperparameter.

17. The method of claim 15, wherein scaling each element of the initial binarized output comprises:
applying a LayerNorm operation to the initial binarized output.

18. The method of claim 17, wherein the binarized feedforward block comprises:
a first feedforward layer followed by a second feedforward layer, wherein:
the first feedforward layer is configured to receive a respective binarized attended layer input for each position, and, for each position:
generate a first initial binarized output for the position, comprising:
computing a binarized matrix multiplication between the binarized attended layer input and a binarized weight matrix for the first binarized feedforward layer;
adding a binarized bias to a product of the binarized matrix multiplication to generate a binarized sum; and
applying a binarized Rectified Linear Unit (ReLU) activation function to the binarized sum to generate the first initial binarized output; and
scale each element of the first initial binarized output by applying a LayerNorm operation to the first initial binarized output to generate a first binarized output for the position.

19. The method of claim 18, wherein the second feedforward layer is configured to receive the respective first binarized output for each position, and, for each position:
generate a second initial binarized output for the position, comprising:
computing a second binarized matrix multiplication between the first binarized output and a binarized weight matrix for the second binarized feedforward layer; and
adding a second binarized bias to a product of the second binarized matrix multiplication to generate a binarized sum; and
scale each element of the second initial binarized output by applying a LayerNorm operation to the second initial binarized output to generate a second binarized output for the position.

20. One or more non-transitory computer-readable storage media storing instructions that when executed by one or more computers cause the one or more computers to implement:
an attention neural network configured to perform the machine learning task, the attention neural network comprising a plurality of attention blocks, each block comprising an attention block and a binarized feedforward block,
the attention block configured to:
receive an input sequence for the block comprising a respective layer input at each of one or more positions; and
generate an attended input sequence at least in part by applying an attention mechanism to the input sequence for the block, the attended input sequence comprising a respective attended layer input at each of the one or more positions, and
the binarized feedforward block comprising a plurality of binarized feedforward layers that are each configured to, for each of the one or more positions:
receive a binarized input derived from the attended layer input at the position;
generate an initial binarized output for the position, comprising computing a binarized matrix multiplication between the binarized input and a binarized weight matrix for the binarized feedforward layer; and
scale each element of the initial binarized output to generate a final output of the binarized feedforward layer.
